(19) United States
(12) Patent Application Publication
(10) Pub. No.: US 2023/0073180 A1
(43) Pub. Date: Mar. 9, 2023

(54) SAMPLE COLLECTION DEVICE

(71) Applicant: Meso Scale Technologies, LLC., Rockville, MD (US)

(72) Inventors: John H. KENTEN, Boyds, MD (US); George SIGAL, Rockville, MD (US)

(21) Appl. No.: 17/930,196

(22) Filed: Sep. 7, 2022

Related U.S. Application Data
(60) Provisional application No. 63/241,668, filed on Sep. 8, 2021.

(51) Int. Cl. G01N 1/18

(52) U.S. Cl. CPC G01N 1/18; G01N 2001/1025

(57) ABSTRACT

A sample collection device having a sample container, a solid phase binding material, and a container sealing component is presented. The sample container may have a housing that forms an opening for receiving a sample, and that encloses a space for holding the sample. The solid phase binding material may be disposed within the space enclosed by the housing of the sample container and may be adapted, when the sample contains an analyte, to bind specifically to the analyte. The container sealing component may be removably attachable to the sample container at the opening thereof, and may be adapted, when attached to the sample container, to form a seal around the opening of the sample container.

### RELATED APPLICATIONS

The present application claims priority to U.S. Provisional Application No. 63/241,668, filed on Sep. 8, 2021 and titled “Sample Collection Device,” which is hereby incorporated by reference in its entirety.

### TECHNICAL FIELD

The present application relates generally to a sample collection device for collecting and/or storing a biological sample or any other sample.

### BACKGROUND

Various methods and systems have been developed for conducting assays in fields such as medical diagnosis, drug discovery, environmental monitoring, food and beverage testing, and scientific research. Such assays may be performed on various samples, which may often be collected at remote sites and transported to a laboratory to perform the assays. The assays may detect or measure an analyte of interest in the sample, such as a protein or other molecule. For instance, a lateral flow immunoassay may detect presence of antibodies in the sample. However, some samples, may have a relatively low concentration of certain analytes or may have variable concentrations from one sample to the next for reasons unrelated to the need for conducting the assay. The low or variable concentration of the analyte may impair an ability of some assays to accurately detect and/or measure the analyte. Thus, a device and technique are needed to increase a concentration of the analyte in a collected sample or to normalize for the variables affecting analyte concentration. The device and method have other uses as described herein.

### BRIEF SUMMARY

Applicants have created a sample collection device for collecting a biological sample or any other sample. The sample collection device may be used to store the sample and/or to transport the sample to a laboratory or other site at which the sample may be analyzed via, e.g., an assay. The sample collection device may be used to increase a concentration and/or purity of an analyte of interest in the sample, so as to facilitate an ability of the assay to detect or measure the analyte.

In various embodiments, the sample collection device may include a sample container for storing the sample, a solid phase binding material disposed within the sample container, and a container sealing component, such as a cap, for creating a seal around the sample container to prevent leakage of the container’s content. The solid phase binding material may be used to increase a concentration of the analyte before the assay is performed. In some instances, the solid phase binding material may exhibit a relatively high level of affinity to the analyte. The affinity may cause the analyte to bind to the solid phase binding material in a higher concentration relative to the analyte’s concentration in the sample. The higher concentration may lead to a more accurate and reliable assay result. In some instances, the solid phase binding material may increase a purity of the sample. The higher purity may be achieved, e.g., by binding the analyte of interest to the solid phase binding material, while washing out or otherwise removing components in the sample which may interfere with the accuracy of the assay and lead to a sample matrix effect.

In a further embodiment, the sample collection device may include a container sealing component which forms a compartment that holds a fluid, e.g., adapted to stabilize a property of the biological sample or adapted to resuspend the analyte bound to the solid phase binding material. The sample collection device may be adapted to cause the fluid to be released from the fluid compartment into the sample container when the container sealing component is attached to or is being attached to the sample container.

In a further embodiment, the container sealing component may be a cap that includes a membrane which forms at least part of the fluid compartment. The sample container may be adapted, when being attached to the container cap, to pierce the membrane to cause the fluid within the fluid compartment to be released into the space enclosed by the housing of the sample container.

In a further embodiment, the container sealing component may form a compartment which holds the solid phase binding material. The sample collection device may be adapted to cause the solid phase binding material to be released from the compartment into the sample container when the container sealing component is attached to or is being attached to the sample container.

In a further embodiment, the sample collection device may have a first opening located at a first end of the sample collection device, and have a second opening located at a second end of the sample collection device. The sample collection device in this embodiment may include a first container sealing component which is removably attached to the first end of the sample container, and include a second container sealing component which is removably attached to the second end of the sample container. The sample container is adapted, when an eluent is delivered into the sample container, to allow the eluent to flow from the first opening toward the second opening of the sample container.

In a further embodiment, the solid phase binding material may be disposed between the first opening and the second opening of the sample container. The sample collection device further may comprise a retention material, such as a porous frit, disposed between the solid phase binding material and the second opening of the sample container. The retention material may be adapted to retain the solid phase binding material within the sample container when the eluent is moving through the sample container.

In a further embodiment, the sample collection device may include a funnel for aiding collection of the biological sample, wherein the funnel is adapted to fit around the opening of the sample container, and to increase in width or diameter as the funnel extends in a direction away from the opening.

In a further embodiment, solid phase binding material forms a first pad disposed in the sample container. The sample collection device includes a second pad formed from a nonspecifically absorbent material, and disposed below the solid phase binding material.

In a further embodiment, the sample collection device includes a component to equalize pressure between opposite sides of a sample as liquid content of the sample flows through a sample container of the sample collection device.

The solid phase binding material may include a variety of materials, such as a ligand, antibodies, proteins adapted to bind specifically to antibodies, a matrix of beads, resin, or any other material.

The sample container may have a variety of shapes and volumes, such as the shape of a tube or column, and may have a volume in a variety of ranges, such as the range of 1 mL to 20 mL, 50 µL to 1 mL, or a volume greater than 20 mL.

Further features as well as the structure and operation of various embodiments are described in detail below with reference to the accompanying drawings.

### BRIEF DESCRIPTION OF THE DRAWINGS

The following FIG. form part of the present specification and are included to further demonstrate certain aspects of the present invention. The invention may be better understood by reference to one or more of these figures in combination with the detailed description of specific embodiments presented herein.

FIG. 1 depicts an embodiment of a sample collection device in accordance with certain aspects of the disclosure.

FIGS. 2A and 2B depict an embodiment of a sample collection device in accordance with certain aspects of the disclosure.

FIGS. 3A and 3B depict an embodiment of a sample collection device having a first opening and a second opening, in accordance with certain aspects of the disclosure.

FIGS. 4A and 4B depict an embodiment of a sample collection device having a retention material, in accordance with certain aspects of the disclosure.

FIG. 5 depicts a sample collection device that has a container sealing component which includes a compartment for storing a stabilizer fluid, in accordance with certain aspects of the disclosure.

FIG. 6 depicts a sample collection device that has a container sealing component which includes a compartment for storing a solid phase binding material, in accordance with certain aspects of the disclosure.

FIG. 7 depicts a sample collection device that has a container sealing component which includes compartments for storing a stabilizer fluid and a solid phase binding material, in accordance with certain aspects of the disclosure.

FIGS. 8A-8B and 9A-9B depict sample collection devices having a funnel which facilitates delivery of samples into the sample collection devices, in accordance with certain aspects of the disclosure.

FIG. 10 depicts a sample collection device adapted to equalize air pressure between a first portion of a sample container and a second portion of the sample container.

### DETAILED DESCRIPTION

Embodiments described herein provide technical solutions to various technical problems. Among the technical problems addressed by embodiments discussed herein involve situations in which a sample needs to be analyzed (e.g., via an assay) to detect or measure presence of a particular analyte, but the concentration of the analyte in the sample is too low to support an accurate or reliable analysis result.

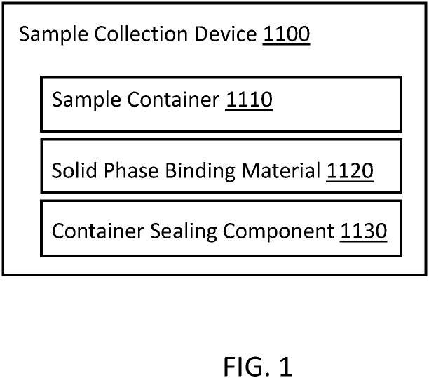

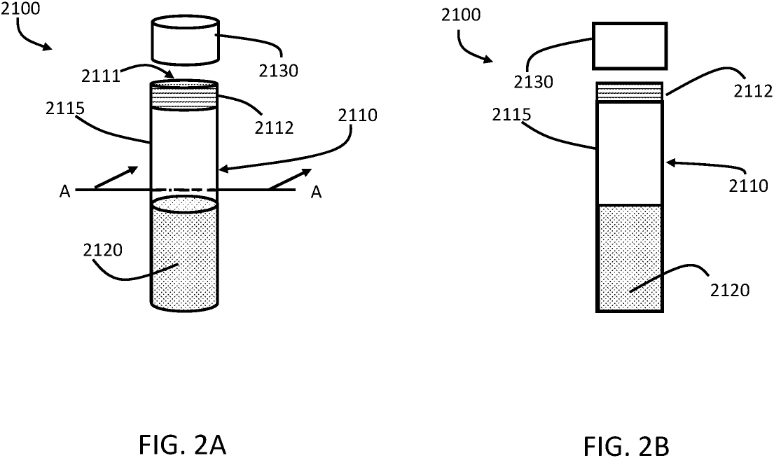

This disclosure presents embodiments of a sample collection device for collecting and storing a sample, such as a biological sample, and for improving a concentration and/or purity of an analyte of interest in the collected sample, so as to facilitate detection and measurement of the analyte. FIG. 1 provides an example of such a sample collection device 1100, which may include a sample container 1110, solid phase binding material 1120, and a container sealing component 1130. The sample container 1110 may be used to receive the sample, and may hold or otherwise store the sample, so as to facilitate transport of the sample from a sample collection site to an analysis site, such as a laboratory in which an assay (e.g., immunoassay or serology assay) is performed on the sample. The sample may be, e.g., a biological sample (e.g., saliva, urine, sweat, tears, blood), an environmental sample, a food sample, or any other sample. As illustrated below in more detail, the sample container 1110 may include or otherwise provide a housing for storing the sample. The housing of the sample container 1110 may form an opening for receiving the sample, and may enclose a space for holding the sample. In other words, the housing may form a compartment 2115 (see, e.g., FIG. 2A) for holding the sample. The sample container 1110 may be sealed via the container sealing component 1130, such as a cap, which may be removably attachable to the sample container. That is, the container sealing component 1130 may be removeable from the sample container 1110 so as to allow a sample to be deposited into or extracted from the opening of the container 1110, and may be attachable to the sample container 1110 so as to form a seal that prevents the sample or other content from leaking out of the sample container 1110.

In various embodiments, the solid phase binding material 1120 may be adapted to bind specifically to an analyte of interest (e.g., a protein, antibody, antigen, cell, or cell component). More particularly, the solid phase binding material 1120 may exhibit a high level of affinity to the analyte, relative to a level of affinity between the analyte and other materials. Thus, the solid phase binding material 1120 may be adapted to bind specifically to the analyte (if any) in the biological sample. The specific binding may also be referred to as selective binding, because the solid phase binding material may exhibit a relatively high level of affinity to the analyte, while exhibiting relatively low affinity or no affinity towards other materials. As a result, the solid phase binding material 1120 may bind specifically to the analyte, and may have a much lower level of binding (e.g., ten times lower) or no binding with other materials.

As stated above, the solid phase binding material 1120 may improve a concentration and/or purity of an analyte in a collected sample. In various embodiments, the collected sample may have a relatively low concentration of the analyte. For instance, a liquid biological sample such as urine or saliva may have a relatively high volume of liquid content, but a relatively low concentration of various analytes of interest, such as specific types of antibodies. The low concentration of the analyte may limit an accuracy or reliability of various assays, such as a lateral flow immunoassay performed directly using the sample. By exhibiting a relatively high level of affinity toward the analyte of interest, the solid phase binding material 1120 may draw the analyte from the liquid content by binding to the analyte, and thus may tend to concentrate the analyte in the solid phase binding material 1120. As discussed below in more detail, elution may be performed to release the analyte from the solid phase binding material 1120 in some embodiments. The elution may cause the analyte to be released by or into an eluent that flows through the solid phase binding material 1120, wherein the eluent may flow into, e.g., a multi-well plate on which an assay is performed. The concentration of the analyte in the eluent or other solution in the multi-well plate may be relatively high, because the solid phase binding material 1120 may have a relatively high concentration of the analyte, and because the elution may be performed in a manner that limits a total volume of the eluent. As further discussed below, the specific binding of the solid phase binding material 1120 to the analyte may help retain the analyte with the material 1120 during one or more washing steps, in which other material is removed, which may increase a purity of the analyte and remove components that may lead to a sample matrix effect or other inaccuracies in an assay.

FIG. 2A illustrates a perspective view of a sample collection device 2100, which may be an embodiment of the sample collection device 1100, while FIG. 2B provides a cross-sectional view of the sample collection device as viewed along the line A-A in FIG. 2A. The sample collection device 2100 in FIGS. 2A and 2B may include a sample container 2110, solid phase binding material 2120, and a container sealing component 2130 (which may be embodiments of the sample container 1110, solid phase binding material 1120, and container sealing component 1130, respectively, of FIG. 1).

In various embodiments, the sample container 2110 may form a tube, column, bottle, vial, or other structure which encloses a space or compartment for storing or otherwise holding a sample, and may have an opening 2111 for receiving the sample. The sample may be collected from a sample collection site, and stored in the sample container 2110 so that the sample can be transported to a laboratory or other analysis site. As stated above, the sample may be, e.g., a biological sample, an environmental sample, a food sample, or any other sample. For instance, the biological sample may include, e.g., saliva, blood, urine, wound exudate, a nasal swab, and/or a nasophryngeal mucosal swab. The environmental sample may include, e.g., drinking water, wastewater, soil extract, and/or a plant extract, such as a leaf swab. In some instances, the environmental sample may include air collected from a particular environment, so that air quality can be assessed. The sample container 2110 may have a volume that is large enough to hold a desired amount of the sample. For instance, the sample container 2110 may have a volume that is in a range from, e.g., 50 µL to 1 mL (e.g., to collect a sample on which an assay can be directly performed), 1 mL to 20 mL (e.g., to collect a sample for which an analyte may be concentrated before an assay is performed), or a volume greater than 20 mL (e.g., to collect a wastewater sample). Further, the sample container 2110 may have a cylindrical shape, as illustrated in FIG. 2A, or may have any other shape (e.g., a rectangular shape).

In various embodiments, the container sealing component 2130 may be a cap which is removably attachable to the sample container 2110 at the opening 2111 of the container 2110, so as to form a seal around the opening 2111 when the container sealing component 2130 is attached to the container 2110. In this example, the sample container 2110 may form a threaded portion 2112 that is located at a first end (e.g., top end) of the sample container 2110. The container sealing component 2130 in such an example may have a portion adapted to mate with the threaded portion of the sample container 2110, so as to allow the cap to be screwed onto the threaded portion 2112, which forms the seal around the opening 2111. In some implementations, the container sealing component 2130 may include an O-ring, which may fit around the threaded portion 2112, so as to enhance the seal.

In various embodiments, the solid phase binding material 2120 of FIGS. 2A and 2B is disposed within the space enclosed by the housing of the sample container 2110. As stated above, the solid phase binding material 2120 may be adapted to specifically bind to an analyte of interest. For instance, the solid phase binding material 2120 may be a binding reagent or affinity medium that is adapted to form a binding complex with the analyte. If a biological sample or other sample containing the analyte is deposited in the sample container 2110, the solid phase binding material may be adapted to bind specifically to the analyte in the biological sample. The solid phase binding material 2120 may thus form a purification module or purification matrix that is adapted to increase a level of concentration or purity of the analyte.

The solid phase binding material 2120 includes material which is in a solid phase. For instance, the solid phase binding material 2120 may form a powder, resin (e.g., cross-linked agarose resin), or matrix of beads (e.g., polystyrene-divinylbenzene beads) which provide an absorbent for binding to an analyte. For instance, the solid phase binding material may include a powder having particles which have a particle size that is in a range from 1 µm (micron) to 400 µm. In various embodiments, because the solid phase binding material 2120 has a solid phase, it may absorb liquid content in a sample. The absorption of the liquid may also enhance a concentration of an analyte of interest. For instance, if the analyte of interest is a type of antibodies, such antibodies may be collected via saliva or other biological sample. The biological sample may have a relatively low concentration of such antibodies. Thus, while an assay may be performed directly on the collected saliva or other biological sample to attempt to detect or measure the antibodies, the low concentration of the antibodies in the biological sample may limit an accuracy of a detection result or measurement. The accuracy may further be limited by other components in the sample that may interfere with the detection or measurement of the analyte, which may lead to a sample matrix effect that can limit accuracy. In various embodiments, the solid phase binding material 2120 may address such limitations by absorbing liquid content in the sample and by binding specifically to the analyte of interest. The absorption may reduce a volume of liquid content in the sample, while the specific binding may tend to increase concentration of the analyte in the solid phase binding material. The solid phase binding material 2120 may be washed with an eluent at an analysis site, in preparation for performing an assay or other analysis. As an eluent flows through the solid phase binding material 2120, the eluent may cause the antibodies or other analyte to be released or otherwise disassociated from the solid phase binding material 2120 and be carried with the eluent into, e.g., a multi-well plate. In some implementations, the elution may be performed in a manner which controls a total volume of eluent that is used. For instance, an amount of eluent used in the elution may be less than an amount of liquid content originally present in the biological sample, which may further improve a concentration of the analyte.

As stated above, the solid phase binding material 2120 may exhibit affinity to an analyte of interest, such as a type of antibodies. Further, the level of affinity between the solid phase binding material and the analyte may be relatively high, compared to a level of affinity between the analyte and other materials. In some instances, the analyte of interest in a biological sample may be a type of antigen, such as a fragment of a virus. For example, the biological sample may be collected from a person to evaluate whether that person has been infected with the virus. In such instances, the solid phase binding material 2120 may include antibodies which are adapted to bind specifically to the antigen.

In some instances, the analyte of interest may be a particular type of antibody, such as immunoglobulin G (IgG), IgA, and/or IgM antibodies, in a biological sample. For example, the biological sample may be collected from a person to evaluate an effectiveness of a vaccine in triggering that person to produce such antibodies. In such instances, the solid phase binding material 2120 may include, e.g., a protein (e.g., protein A, protein A/G, protein G, protein L) adapted to bind specifically to such antibodies.

Other examples of the solid phase binding material 2120 or its components include enzymes, ligands, receptors, nanomolecules, and resins which are adapted to bind specifically to an analyte of interest. For example, the nanomolecules may include nanotrap particles or dye molecules which have a relatively high level of binding to the analyte of interest. As another example, the resins may be, e.g., an ion-exchange resin or reverse-phase resin adapted to bind specifically to the analyte.

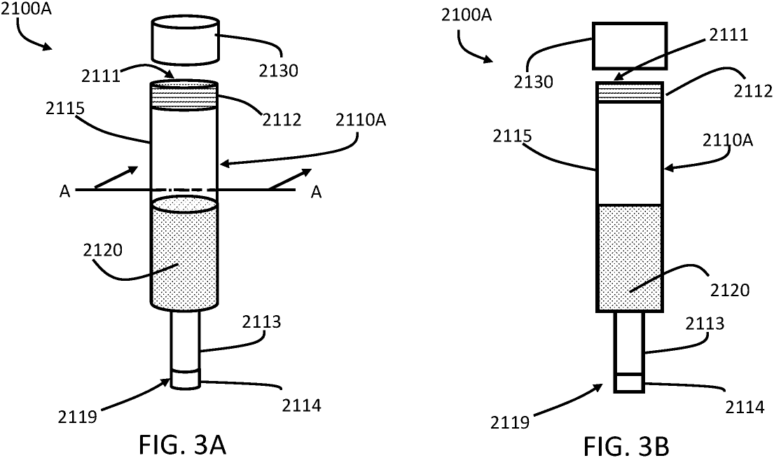

As discussed above, the analyte which is bound to the solid phase binding material 2120 may be eluted from the material 2120, so as to release the analyte for detection, measurement, or other analysis. FIGS. 3A and 3B illustrate a sample collection device 2100A which has openings 2111, 2119 at opposite ends of the device 2100A to facilitate an elution process that releases the analyte from the solid phase binding material 2120. The sample collection device 2100A may include the solid phase binding material 2120, a container 2110A, and container sealing components 2130, 2114. The sample container 2110A may have an opening 2111 at a first end (e.g., top end) of the container 2110A, and an opening 2119 at a second, opposite end (e.g., bottom end) of the container 2110A. The opening 2111 may lead to a compartment 2115 for holding or otherwise storing the solid phase binding material 2120 and a sample, while the sample container 2110A may include a passage 2113 that leads from the compartment 2115 to the opening 2119. In the example of FIGS. 3A and 3B, the passage 2113 may be formed from a tube, pipe, or other structure, and this structure may be narrower relative to the compartment 2115.

In various embodiments, container sealing component 2114 may be removably attachable to the second end of the container 2110A, so as to provide an ability to form a seal around the opening 2119 at the second end of the container 2110A. Further, as discussed above, the container sealing component 2130 may be removably attachable to the first end of the container 2110A, so as to provide an ability to form a seal around the opening 2111 at the first end of the container 2110A. When a sample is being transported and/or stored in the sample collection device 2100A, both container sealing components 2130, 2114 may be attached to the sample container 2110A, so as to prevent any content of the container 2110A from leaking out of the container 2110A. When an assay is to be performed on the biological sample, both of the container sealing components 2130, 2114 may be removed from the container 2110A, so as to allow for an elution process that causes the analyte to the released from the solid phase binding material 2120. The elution may be performed by causing an eluent to flow from the opening 2111 of the container 2110A toward the opening 2119 thereof, so that the eluent passes through the solid phase binding material 2120 to cause an analyte to be released from the solid phase binding material into the eluent.

In some instances, one or more washing steps may be performed on the solid phase binding material 2120 in a manner which filters out interfering components, such as contaminants which may interfere with the performance of an assay, so as to purify a sample before an eluent is passed through the sample. During the one or more wash steps, a wash fluid may be passed through the solid phase binding material 2120. The wash fluid may have relatively weak affinity or no affinity to the analyte, and thus may wash out interfering components while leaving the analyte bound to the solid phase binding material 2120. The analyte may later be released from the solid phase binding material 2120 during the elution step.

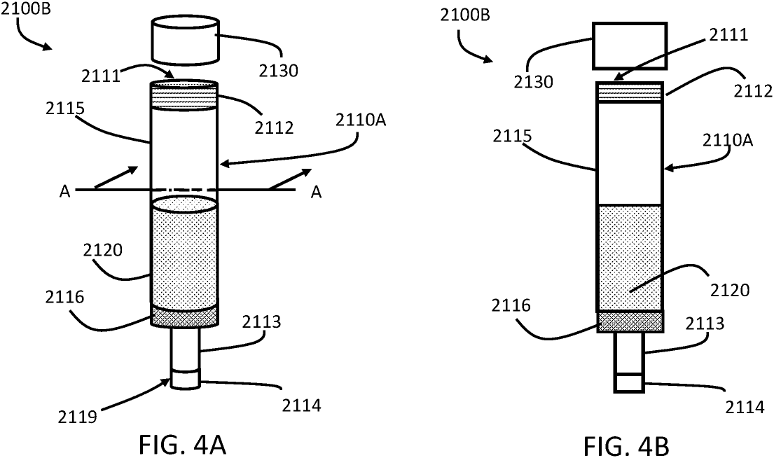

In various embodiments, a retention material may be used to retain the solid phase binding material 2120 within the sample container 2110A during elution. For example, FIGS. 4A-4B depict a sample collection device 2100B which includes the solid phase binding material 2120, sample container 2110A, and container sealing components 2130, 2114 discussed above. The sample collection device 2100B further includes a retention material 2116 disposed between the solid phase binding material 2120 and the opening 2119 at the second end of the container 2110A. If an analyte of interest is disassociated from the solid phase binding material 2120 during elution, the retention material 2116 may be adapted to an allow the analyte to be carried by an eluent out of the opening 2119 during elution, but may keep the solid phase binding material 2120 from also being carried out by the eluent. Thus, the retention material may provide a filter that prevents particles of the solid phase binding material 2120, or any other material which is not the analyte, from flowing out of the opening 2119. In some implementations, the retention material 2116 may include a porous frit which retains the solid phase binding material 2120 within the container 2110A. In one example, the porous frit may, include particles with particle sizes that are, e.g., in a range of 0.1 µm to 400 µm, or more specifically in a range of 1 µm to 50 µm.

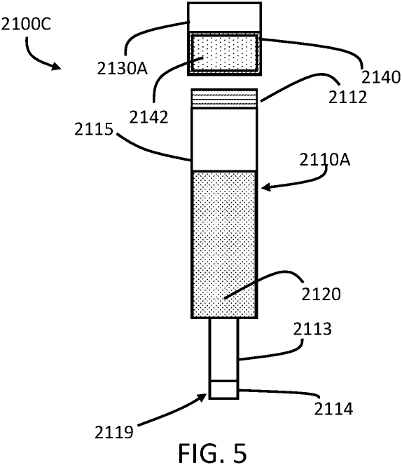

In various embodiments, a sample collection device may have a container sealing component that forms a compartment(s) for various material(s), wherein the compartment(s) may be disposed within or attached to the container sealing component. FIG. 5 depicts a sample collection device 2100C that includes the sample container 2110A and the solid phase binding material 2120 of the previous figures, and further includes a container sealing component 2130A which may form a compartment 2140 for holding or otherwise storing a stabilizer fluid 2142, which may be a fluid adapted to stabilize a property of a sample. For instance, stabilizer fluid 2142, also referred to as a stabilizer solution or stabilizer buffer, may prevent or slow a rate of deterioration of the sample, wherein the deterioration may occur as a result of, e.g., denaturation, aggregation, and/or precipitation of an analyte or other components in the sample. In some implementations, the fluid 2142 may inhibit bacterial growth in the sample, maintain a pH of the sample at a specified level or within a specified range, and/or stabilize some other property in the sample, such as a level of folding and/or solubility of an analyte of interest in the sample. If the sample collection device 2100C is being transported to from a sample collection site to an analysis site (e.g., a laboratory), the stabilizer fluid 2142 may stabilize the sample while the device 2100C is in transit.

In various embodiments, the sample collection device 2100C may be adapted to cause the stabilizer fluid to be released from the compartment 2140 into the sample container 2110A when the container sealing component 2130A (e.g., cap) is attached to or is being attached to the sample container 2110A. For example, the container sealing component 2130A may be a cap that includes a membrane, such as a plastic film, that seals off a space within the cap from an external environment. The space may provide the compartment 2140 for the stabilizer fluid 2142, while the membrane may define at least part of a boundary of the compartment 2140. In this example, the sample container 2110A may be adapted, when being attached to the container sealing component 2130A, to pierce the membrane to cause the stabilizer fluid 2142 to be released from within the compartment 2140 into the space/compartment 2115 enclosed by the housing of the sample container 2110A. For instance, the sample collection device 2100A may have a threaded portion 2112 which is adapted to make contact with the membrane when the sample container 2110A is attached or being attached to the container sealing component 2130A. The threaded portion 2112 may be sufficiently sharp to pierce the membrane when the threaded portion 2112 makes contact with the membrane, so as to cause the stabilizer fluid 2142 to leak out of the compartment 2140 and into the compartment 2115 formed by the sample container 2110A.

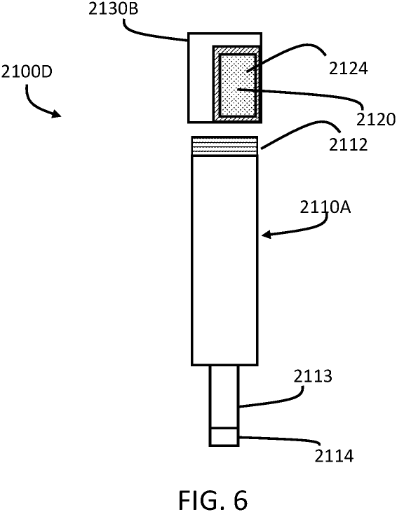

In various embodiments, a container sealing component may include a compartment for holding or otherwise storing the solid phase binding material 2120. For example, FIG. 6 depicts a sample collection device 2100D which includes the sample container 2110A discussed above, and further includes a container sealing component 2130B (e.g., cap) that forms a compartment 2124 for holding the solid phase binding material 2120. In some instances, the compartment 2124 may include a solution for keeping the solid phase binding material 2120 hydrated. Like the discussion regarding FIG. 5, the compartment 2124 may similarly be formed by a membrane, which may define at least part of a boundary of the compartment 2124. The sample container 2110A in this embodiment may also be adapted to pierce the membrane when the container 2110A is attached or being attached to the container sealing component 2130B. As a result, the solid phase binding material 2120 may be released from the compartment 2124 into the sample container 2110A.

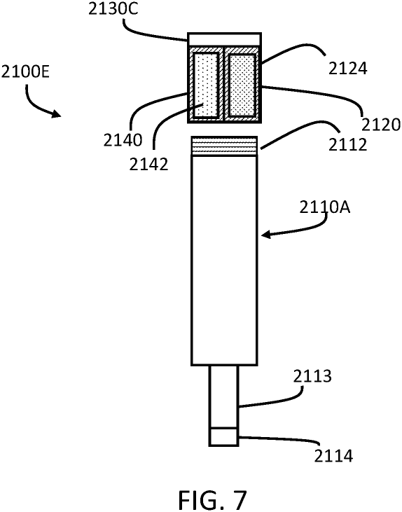

In various embodiments, both the solid phase binding material 2120 and the stabilizer fluid 2142 may be stored in a container sealing component. More specifically, FIG. 7 depicts a container sealing component 2130C which has both the compartment 2140 storing the stabilizer fluid 2142 and the compartment 2124 storing the solid phase binding material 2120. Like in the discussion of FIGS. 5 and 6, the sample container 2110A may be configured to pierce the compartments 2140, 2124 when the container 2110A is attached or is being attached to the container sealing component 2130C, so as to cause the stabilizer fluid 2142 and the solid phase binding material 2120 to be released into the container 2110A.

In some instances, a sample container of the embodiments herein (e.g., any one of 2100 through 2100G) may include the solid phase binding material 2120, which has affinity specifically to an analyte of interest, and further include a pad (e.g., cotton pad) or other layer formed from a nonspecifically absorbent material adapted to absorb liquid content in a sample. For example, a sample collection device in such instances may include at least a first pad and a second pad that are disposed within a sample container. The first pad, such as a top pad, may be formed by the solid phase binding material, which may bind specifically to the analyte as a sample is deposited into the sample container and liquid content of the sample (if any) flows downward through the sample container. The second pad may be placed above or below the solid phase binding material of the first pad, and may include the nonspecifically absorbent material. The nonspecifically absorbent material may have general affinity to the liquid content and many different types of material in the liquid content, in a non-selective manner. The nonspecifically absorbent material may thus be adapted to draw liquid content in the sample toward itself. By drawing the liquid content toward itself, the second pad may promote flow or other movement of the liquid content in the sample through the sample container, which may in turn promote flow of the liquid content of the sample through the solid phase binding material. For example, the second pad may be placed below the solid phase binding material, which would cause the solid phase binding material to be sandwiched between the second pad and the opening 2111 of FIG. 2A through 7. When a sample having liquid content, such as a saliva sample, is deposited into the sample container via the opening 2111, the second pad may absorb excess liquid content from the sample, wherein the excess liquid may include liquid content not absorbed by the solid phase binding material. Because the second pad is placed under the solid phase binding material, the absorption of the liquid content by the second pad in this example may promote flow of the liquid content through solid phase binding material. If the liquid content of the sample contains the analyte of interest, then promoting this flow of the liquid content may promote binding of an analyte to the solid phase binding material. In some implementations, the second pad may be considerably thicker (twice as thick) as the first pad, so as to promote absorption of the liquid content in the sample.

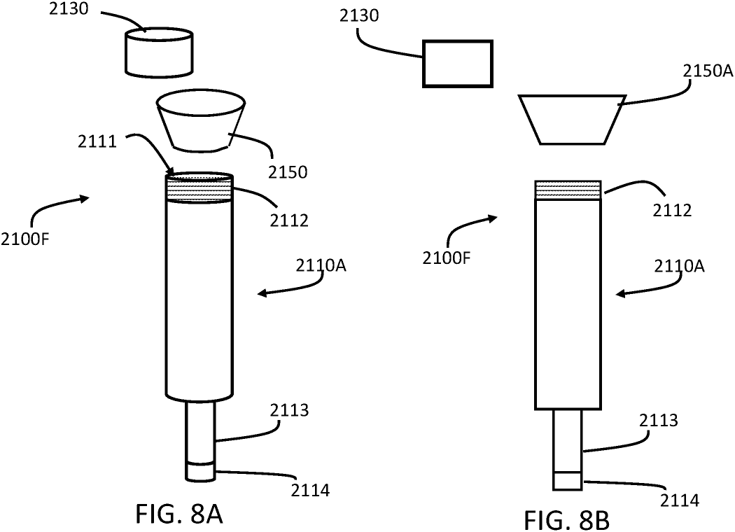

In various embodiments, depositing a sample (e.g., saliva sample) into a sample collection device may require a person or other host at a sample collection site to aim the sample toward an opening of the device’s sample container. A sample collection aid may be included as part of the sample collection device to increase an ease by which the sample can be deposited into the container. The sample collection aid may include, e.g., a straw or a funnel which may be positioned by the person into alignment with the opening of the sample container. For example, FIGS. 8A and 8B depict a sample collection device 2100F that includes the sample container 2110A and the container sealing component 2130 discussed above with respect to FIGS. 3A and 3B, and further includes a funnel 2150. The funnel may have a relatively wide opening at one end of the funnel, so as to increase an ability of the funnel to collect a sample. Further, the funnel may narrow toward an opposite end thereof, so as to guide the sample into the sample container 2110A via the opening 2111 of the container 2110A.

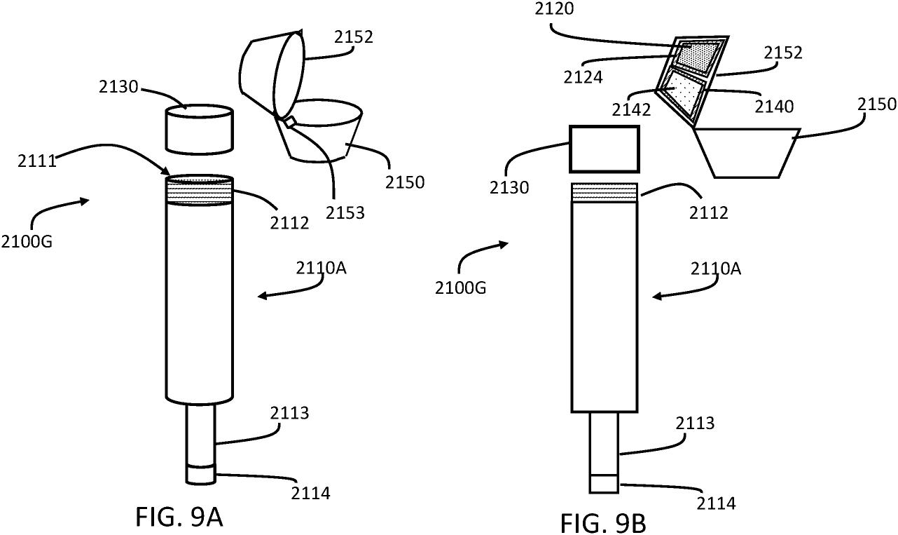

FIGS. 9A and 9B depict a sample collection device 2100G in which the stabilizer fluid 2142 and the solid phase binding material 2120 are disposed in compartments which are within or attached to a storage component 2152. In this example, the sample collection device 2100G may include the sample container 2110A, the container sealing component 2130, and the funnel 2150 of FIGS. 8A and 8B. The funnel 2150 may be part of a funnel assembly which includes the funnel 2150 and the storage component 2152. The storage component 2152 may provide a housing that forms the compartment 2140 for the stabilizer fluid 2142, and forms the compartment 2124 for the solid phase binding material 2120. The storage component 2152 may be attached to the funnel 2150 via a hinge or other attachment mechanism. The hinge may allow the storage component 2152 to be folded toward the funnel 2150 and folded away from the funnel 2150. In some implementations, the compartments 2140 and 2124 may be formed with membranes, and the funnel assembly in these implementations may include a component or structure 2153 (e.g., a sharp structure) which is adapted to pierce the membranes when the storage component 2152 is folded toward the funnel 2150. In this embodiment, a person may use the funnel 2150 of the funnel assembly as a sample delivery aid to deposit a sample into the sample container 2110A. Before or after the person delivers the sample into the sample container 2110A, the person may cause the membranes to be pierced, such as by folding the storage component 2152 toward the funnel 2150, so that the stabilizer fluid 2142 and the solid phase binding material 2120 are released into the sample container 2110A. After the sample, the stabilizer fluid 2142, and the solid phase binding material 2120 are deposited into the sample container 2110A, the container 2110A may be sealed via the container sealing component 2130.

In various embodiments, a sample collection device may have a mechanism to equalize pressure as liquid content of a sample flows or otherwise moves through a sample container, especially when the sample container is sealed. For instance, if the sample container has a vertical orientation, the liquid content may flow downward while passing through the solid phase binding material. As the liquid content flows downward, the air or other gas beneath the liquid content may become compressed and build up in pressure, while the air or other gas above the liquid content may expand and decrease in pressure. This pressure difference between opposite sides of the liquid content may stop or slow movement of the liquid content of the sample through the sample container, and more specifically through the solid phase binding material, which may impair an ability of the solid phase binding material to bind to the analyte.

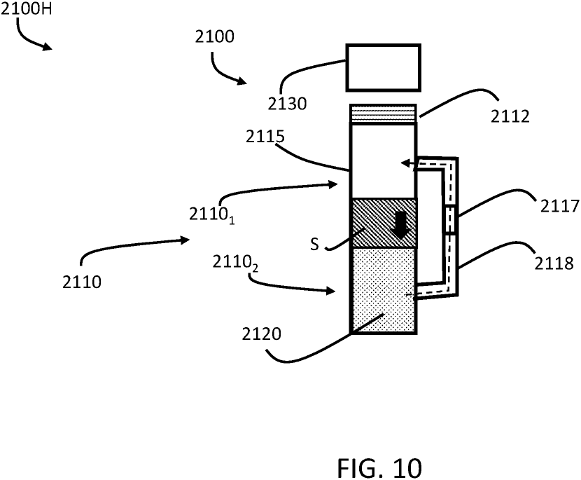

In some implementations, the sample container may include a one-way air valve to compensate for the pressure difference on opposite sides of the sample. For instance, FIG. 10 depicts a sample collection device 2100H which has the sample container 2110 and the container sealing component 2130, and further includes a tube 2118 and a one-way air valve 2117. As liquid content of a sample S flows downward from a top portion 2110₁ of the sample container 2110 toward a bottom portion 2110₂ of the container 2110, the tube 2118 and/or air valve 2117 may aid in equalizing air pressure between the top portion 2110₁ and the bottom portion 2110₂. More particularly, the one-way air valve 2117 in this example may allow air or other gas to travel from one portion of the sample container 2110, such as the bottom portion 2110₂ that is below the liquid content of the sample S, to another portion, such as the top portion 2110₁ of the sample container which is above the liquid content of the sample S. Further, the one-way air valve 2117 may limit or prevent passage of air in the other direction. In such an example, as liquid content from a sample S flows downward, the downward flow may cause air pressure below the liquid content to rise above air pressure above the liquid content. This may create a pressure difference that opposes the downward flow of the sample S, which may interfere with an ability of the solid phase binding material 2120 to bind to an analyte in the sample S. The one-way air valve 2117 in this example may allow the higher air pressure to push air from a bottom portion 2110₂ of the sample container into a top portion 2110₁ of the sample container, which may cause top portion 2110₁ and the bottom portion 2110₂ of the sample container 2110 to equalize in terms of air pressure. In one implementation, the sample collection device may include a tube 2118. The tube 2118 may be provided in addition to the air valve 2117, as illustrated in FIG. 10, or may be provided instead of the one-way air valve. The tube 2118 may permit flow of air from the bottom portion 2110₂ of the sample container to the top portion 2110₁ of the sample container 2110, so as to equalize air pressure between the top portion 2110₁ of the container and the bottom portion 2110₂ of the container 2110.

Additional embodiments of the present application include:

Embodiment 1 includes a sample collection device, comprising a sample container having a housing that forms an opening for receiving a sample, and that encloses a space for holding the sample; a solid phase binding material disposed within the space enclosed by the housing of the sample container and adapted, when the sample contains an analyte, to bind specifically to the analyte; and a container sealing component removably attachable to the sample container at the opening thereof, wherein the container sealing component is adapted, when attached to the sample container, to form a seal around the opening of the sample container.

Embodiment 2 includes the sample collection device of embodiment 1, wherein the housing of the sample container forms a tube or a column.

Embodiment 3 includes the sample collection device of embodiment 2, wherein the tube or column has a volume that is in a range from 1 mL to 20 mL.

Embodiment 4 includes the sample collection device of embodiment 2, wherein the tube or column has a volume that is in a range from 50 µL to 1 mL.

Embodiment 5 includes the sample collection device of embodiment 2, wherein the tube or column has a volume that is greater than 20 mL.

Embodiment 6 includes the sample collection device of any one of embodiments 1-5, wherein the container sealing component forms a fluid compartment that holds a fluid adapted to stabilize a property of the sample, and wherein the sample collection device is adapted to cause the fluid to be released from the fluid compartment into the sample container when the container sealing component is attached to or is being attached to the sample container.

Embodiment 7 includes the sample collection device of of embodiment 6, wherein the container sealing component is a container cap that includes a membrane which forms at least part of the fluid compartment, and wherein the sample container is adapted, when being attached to the container cap, to pierce the membrane to cause the fluid within the fluid compartment to be released into the space enclosed by the housing of the sample container.

Embodiment 8 includes the sample collection device of any of embodiments 1-7, wherein the opening of the sample container is a first opening, and is located at a first end of the sample collection device, and wherein the container sealing component is a first container sealing component, wherein the sample container has a second opening located at a second end of the sample collection device, wherein the sample collection device has a second container sealing component which is removably attached to the second end of the sample container and is adapted to seal the second opening of the sample container, and wherein the sample container is adapted, when an eluent is delivered into the sample container, to allow the eluent to move from the first opening toward the second opening of the sample container.

Embodiment 9 includes the sample collection device of embodiment 8, wherein the solid phase binding material is disposed between the first opening and the second opening of the sample container, and wherein the sample collection device further comprises a retention material disposed between the solid phase binding material and the second opening of the sample container, wherein the retention material is adapted to retain the solid phase binding material within the sample container when the eluent is moving through the sample container.

Embodiment 10 includes the sample collection device of device of embodiment 9, wherein the retention material includes a porous frit having pore sizes which are in a range from 0.1 µm to 400 µm.

Embodiment 11 includes the sample collection device of any one of embodiments 1-10, wherein the solid phase binding material is adapted to cause a concentration of the analyte in the solid phase binding material to be higher than a concentration of the analyte in the sample.

Embodiment 12 includes the sample collection device of any one of embodiments 1-11, wherein the solid phase binding material is formed by particles having particle sizes which are in a range from 1 µm to 400 µm.

Embodiment 13 includes the sample collection device of any one of embodiments 1-12, wherein the solid phase binding material includes a ligand.

Embodiment 14 includes the sample collection device of any one of embodiments 1-13, further comprising a funnel for aiding collection of the sample, wherein the funnel is adapted to fit around the opening of the sample container, and to increase in width or diameter as the funnel extends in a direction away from the opening.

Embodiment 15 includes the sample collection device of of any one of embodiments 1-14, wherein the solid phase binding material is configured, when the analyte in the sample are antibodies, to bind specifically to the antibodies.

Embodiment 16 includes the sample collection device of of embodiment 15, wherein the solid phase binding material is configured to bind to at least one of: IgG antibodies, IgA antibodies, or IgM antibodies.

Embodiment 17 includes the sample collection device of of embodiment 15 or 16, wherein the solid phase binding material includes at least one of protein A or protein A/G.

Embodiment 18 includes the sample collection device of of any one of embodiments 1-17, wherein the solid phase binding material forms a first pad disposed in the sample container, and wherein the sample collection device includes a second pad formed from an absorbent material, the second pad also being disposed in the sample container, wherein the first pad is disposed on top of the second pad when the sample container has an orientation in which the opening of the sample container is located at a top of the sample container.

Embodiment 19 includes the sample collection device of of embodiment 18, wherein the second pad is bigger than the first pad, and does not specifically bind to the analyte in the sample.

Embodiment 20 includes the sample collection device of of any one of embodiments 1-19, further comprising a one-way air valve adapted, when the container sealing component has formed the seal around the opening of the sample container and the sample is in a liquid passing from a top of the sample container to a bottom of the sample container, to equalize an amount of air pressure at a first portion of the sample container above the liquid with an amount of air pressure at a second portion of the sample container below the liquid.

Embodiment 21 includes the sample collection device of of any one of embodiments 1-20, further comprising a tube that permits flow of air from a bottom of the sample container to a top of the sample container, wherein the tube is adapted, when the container sealing component has formed the seal around the opening of the sample container and the sample is in a liquid passing from a top of the sample container to a bottom of the sample container, to equalize an amount of air pressure at a first portion of the sample container above the liquid with an amount of air pressure at a second portion of the sample container below the liquid, and wherein the tube is disposed within the sample container, or is external to the sample container.

Embodiment 22 is a sample collection device comprising: a sample container having a housing that forms a first opening for receiving a biological sample, and that encloses a space for holding the biological sample, wherein the first opening of the sample container is located at a first end thereof, and wherein the housing further forms a second opening at a second and opposite end of the sample container; a solid phase binding material disposed within the space enclosed by the housing of the sample container and adapted, when the biological sample contains antibodies, to bind to the antibodies; a first container sealing component removably attachable to the sample container at the first opening thereof, wherein the first container sealing component is adapted, when attached to the sample container, to form a seal around the first opening of the sample container, wherein the first container sealing component forms a compartment which holds a fluid adapted to stabilize a property of the biological sample; and a second container sealing component removably attachable to the sample container at the second opening thereof and adapted, when attached to the sample container, to form a seal around the second opening of the sample container, wherein the sample collection device is adapted to cause the fluid for stabilizing the property of the biological sample to be released from the compartment into the sample container when the first container sealing component is attached to or is being attached to the sample container, and wherein the sample container is adapted, when an eluent is delivered into the sample container, to allow the eluent to move from the first opening toward the second opening of the sample container.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The embodiments described above are illustrative examples and it should not be construed that the present invention is limited to these particular embodiments. It should be understood that various embodiments disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the methods or processes). In addition, while certain features of embodiments hereof are described as being performed by a single module or unit for purposes of clarity, it should be understood that the features and functions described herein may be performed by any combination of units or modules. Thus, various changes and modifications may be affected by one skilled in the art without departing from the spirit or scope of the invention as defined in the appended claims.

What is claimed is:

1. A sample collection device, comprising:
a sample container having a housing that forms an opening for receiving a sample, and that encloses a space for holding the sample;
a solid phase binding material disposed within the space enclosed by the housing of the sample container and adapted, when the sample contains an analyte, to bind specifically to the analyte; and
a container sealing component removably attachable to the sample container at the opening thereof, wherein the container sealing component is adapted, when attached to the sample container, to form a seal around the opening of the sample container.

2. The sample collection device of claim 1, wherein the housing of the sample container forms a tube or a column.

3. The sample collection device of claim 2, wherein the tube or column has a volume that is in a range from 1 mL to 20 mL.

4. The sample collection device of claim 2, wherein the tube or column has a volume that is in a range from 50 µL to 1 mL.

5. The sample collection device of claim 2, wherein the tube or column has a volume that is greater than 20 mL.

6. The sample collection device of claim 1, wherein the container sealing component forms a fluid compartment that holds a fluid adapted to stabilize a property of the sample, and
wherein the sample collection device is adapted to cause the fluid to be released from the fluid compartment into the sample container when the container sealing component is attached to or is being attached to the sample container.

7. The sample collection device of claim 6, wherein the container sealing component is a container cap that includes a membrane which forms at least part of the fluid compartment, and
wherein the sample container is adapted, when being attached to the container cap, to pierce the membrane to cause the fluid within the fluid compartment to be released into the space enclosed by the housing of the sample container.

8. The sample collection device of claim 1, wherein the opening of the sample container is a first opening, and is located at a first end of the sample collection device, and wherein the container sealing component is a first container sealing component,
wherein the sample container has a second opening located at a second end of the sample collection device,
wherein the sample collection device has a second container sealing component which is removably attached to the second end of the sample container and is adapted to seal the second opening of the sample container, and
wherein the sample container is adapted, when an eluent is delivered into the sample container, to allow the eluent to move from the first opening toward the second opening of the sample container.

9. The sample collection device of claim 8, wherein the solid phase binding material is disposed between the first opening and the second opening of the sample container, and
wherein the sample collection device further comprises a retention material disposed between the solid phase binding material and the second opening of the sample container,
wherein the retention material is adapted to retain the solid phase binding material within the sample container when the eluent is moving through the sample container.

10. The sample collection device of claim 9, wherein the retention material includes a porous frit having pore sizes which are in a range from 0.1 µm to 400 µm.

11. The sample collection device of claim 1, wherein the solid phase binding material is adapted to cause a concentration of the analyte in the solid phase binding material to be higher than a concentration of the analyte in the sample.

12. The sample collection device of claim 1, wherein the solid phase binding material is formed by particles having particle sizes which are in a range from 1 µm to 400 µm.

13. The sample collection device of claim 1, wherein the solid phase binding material includes a ligand.

14. The sample collection device of claim 1, further comprising a funnel for aiding collection of the sample, wherein the funnel is adapted to fit around the opening of the sample container, and to increase in width or diameter as the funnel extends in a direction away from the opening.

15. The sample collection device of claim 1, wherein the solid phase binding material is configured, when the analyte in the sample are antibodies, to bind specifically to the antibodies.

16. The sample collection device of claim 15, wherein the solid phase binding material is configured to bind to at least one of: IgG antibodies, IgA antibodies, or IgM antibodies.

17. The sample collection device of claim 16, wherein the solid phase binding material includes at least one of protein A or protein A/G.

18. The sample collection device of claim 1, wherein the solid phase binding material forms a first pad disposed in the sample container, and wherein the sample collection device includes a second pad formed from an absorbent material, the second pad also being disposed in the sample container,
wherein the first pad is disposed on top of the second pad when the sample container has an orientation in which the opening of the sample container is located at a top of the sample container.

19. The sample collection device of claim 18, wherein the second pad is bigger than the first pad, and does not specifically bind to the analyte in the sample.

20. The sample collection device of any one of claim 1, further comprising a one-way air valve adapted, when the container sealing component has formed the seal around the opening of the sample container and the sample is in a liquid passing from a top of the sample container to a bottom of the sample container, to equalize an amount of air pressure at a first portion of the sample container above the liquid with an amount of air pressure at a second portion of the sample container below the liquid.

21. The sample collection device of claim 1, further comprising a tube that permits flow of air from a bottom of the sample container to a top of the sample container,
wherein the tube is adapted, when the container sealing component has formed the seal around the opening of the sample container and the sample is in a liquid passing from a top of the sample container to a bottom of the sample container, to equalize an amount of air pressure at a first portion of the sample container above the liquid with an amount of air pressure at a second portion of the sample container below the liquid, and
wherein the tube is disposed within the sample container, or is external to the sample container.

22. A sample collection device, comprising:
a sample container having a housing that forms a first opening for receiving a biological sample, and that encloses a space for holding the biological sample, wherein the first opening of the sample container is located at a first end thereof, and wherein the housing further forms a second opening at a second and opposite end of the sample container;
a solid phase binding material disposed within the space enclosed by the housing of the sample container and adapted, when the biological sample contains antibodies, to bind to the antibodies;
a first container sealing component removably attachable to the sample container at the first opening thereof, wherein the first container sealing component is adapted, when attached to the sample container, to form a seal around the first opening of the sample container, wherein the first container sealing component forms a compartment which holds a fluid adapted to stabilize a property of the biological sample; and
a second container sealing component removably attachable to the sample container at the second opening thereof and adapted, when attached to the sample container, to form a seal around the second opening of the sample container,
wherein the sample collection device is adapted to cause the fluid for stabilizing the property of the biological sample to be released from the compartment into the sample container when the first container sealing component is attached to or is being attached to the sample container, and
wherein the sample container is adapted, when an eluent is delivered into the sample container, to allow the eluent to move from the first opening toward the second opening of the sample container.
